(19) United States
(12) Patent Application Publication
(10) Pub. No.: US 2004/0050636 A1
(43) Pub. Date: Mar. 18, 2004

(54) Attachment for a wheeled container

(76) Inventor: Frank C. Forbes, Rockwall, TX (US)

Correspondence Address: Frank C. Forbes, 904 Sunpoint Circle, Rockwall, TX, 75087, US

(21) Appl. No.: 10/243,062

(22) Filed: Sep. 13, 2002

(51) Int. Cl. B62B 9/00; B62B 7/00

(52) U.S. Cl. 190/18 A; 280/655

(57) ABSTRACT

An attachment for a wheeled container allows a user to pull wheeled luggage, backpacks or any other wheeled container hands free, while eliminating the twisting and pulling method of pulling wheeled containers necessary for the current models. The present invention has a belt that fits around a user's waist, which is attached to the handle of a wheeled container. This invention is lightweight and easy to use in conjunction with a wheeled suitcase or backpack. It easily snaps quickly into place for use in seconds and adjusts to fit around all sizes of people. It folds into the suitcase handle or backpack harness and can be stowed away therein when not in use.

### BACKGROUND OF THE INVENTION

1. Field of the Invention

The present invention relates to an attachment for a wheeled container for use in connection with pulling a wheeled container, such as luggage or a backpack, with a user's torso instead of with a hand-held handle. The attachment for a wheeled container has particular utility in connection with pulling luggage, backpacks or baby carriages hands free.

2. Description of the Prior Art

Attachments for wheeled containers are desirable for assisting a user in transporting or pulling wheeled containers, such as luggage, backpacks or baby carriages.

The use of attachments for a wheeled container is known in the prior art. For example, U.S. Pat. No. 4,995,487 to Plath discloses a wheeled suitcase and luggage support. However, the Plath '487 patent does not allow a user to pull the luggage hands free, and has further drawbacks of requiring a user to hold the luggage handle with the user's hand while pulling the luggage, which results in a twisting of the user's upper torso.

U.S. Pat. No. 5,351,793 to Gibbs discloses a handle for a wheeled suitcase that has straps instead of a rigid handle which operate as a leash to pull the suitcase. However, the Gibbs '793 patent is not pulled from the user's torso, and additionally does not comprise rigid handles with telescoping bar attachments, which fold into the suitcase to be stored therein when not in use.

Similarly, U.S. Pat. No. 5,630,521 to Waddell et al discloses an ergonomic upright wheeled luggage that comprises four wheels, stands upright in a balanced and stable position without attendance by the user, and can be pushed or pulled by the user with either two or four wheels in use. However, the Waddell '521 patent does not comprise an attachment to be worn around a user's waist, and can not be pulled with a user's torso.

While the above-described devices fulfill their respective, particular objectives and requirements, the aforementioned patents do not describe an attachment for a wheeled container that allows for pulling luggage, backpacks or baby carriages hands free.

Therefore, a need exists for a new and improved attachment for a wheeled container that can be used for pulling luggage, backpacks or baby carriages hands free. In this regard, the present invention substantially fulfills this need. In this respect, the attachment for a wheeled container according to the present invention substantially departs from the conventional concepts and designs of the prior art, and in doing so provides an apparatus primarily developed for the purpose of pulling luggage, backpacks or baby carriages hands free. Also, while walking, jogging or running, this invention is an improvement to the existing method of pushing a wheeled container, since it allows a user to roll over bumps more efficiently.

### SUMMARY OF THE INVENTION

In view of the foregoing disadvantages inherent in the known types of attachments for a wheeled container now present in the prior art, the present invention provides an improved attachment for a wheeled container, and overcomes the above-mentioned disadvantages and drawbacks of the prior art. As such, the general purpose of the present invention, which will be described subsequently in greater detail, is to provide a new and improved attachment for a wheeled container and method which has all the advantages of the prior art mentioned heretofore and many novel features that result in an attachment for a wheeled container which is not anticipated, rendered obvious, suggested, or even implied by the prior art, either alone or in any combination thereof.

To attain this, the present invention essentially comprises a (claim 1 in plain English with a description of essential elements and features)

(Any other essential or primary claims explained)

There has thus been outlined, rather broadly, the more important features of the invention in order that the detailed description thereof that follows may be better understood and in order that the present contribution to the art may be better appreciated.

The invention may also include a pouch attached to the wheeled container suitable for stowing the present invention when not in use. There are, of course, additional features of the invention that will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved attachment for a wheeled container that has all of the advantages of the prior art attachments for a wheeled container and none of the disadvantages.

It is another object of the present invention to provide a new and improved attachment for a wheeled container that may be easily and efficiently manufactured and marketed.

An even further object of the present invention is to provide a new and improved attachment for a wheeled container that has a low cost of manufacture with regard to both materials and labor, and which accordingly is then susceptible of low prices of sale to the consuming public, thereby making such attachment for a wheeled container economically available to the buying public.

Still another object of the present invention is to provide a new attachment for a wheeled container that provides in the apparatuses and methods of the prior art some of the advantages thereof, while simultaneously overcoming some of the disadvantages normally associated therewith.

Even still another object of the present invention is to provide an attachment for a wheeled container for pulling luggage, backpacks or baby carriages hands free. This allows a user to carry or operate other items with the user's hands, such as a cellular phone or other boxes or bags, while also pulling luggage with the user's torso. The present invention also prevents twisting and pulling associated with pulling wheeled luggage with a handle to be pulled by hand.

Lastly, it is an object of the present invention to provide a new and improved method of using an attachment for a wheeled container comprising the steps of securing a belt around a user's waist, locking the belt into place, and walking while pulling the wheeled container via the belt.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a frontal view of the preferred embodiment of the attachment for a wheeled container constructed in accordance with the principles of the present invention.

FIG. 2 is a side view of the attachment for a wheeled container of the present invention.

FIG. 3 is a side view of the attachment for a wheeled container of the present invention.

The same reference numerals refer to the same parts throughout the various figures.

### DESCRIPTION OF THE PREFERRED EMBODIMENT

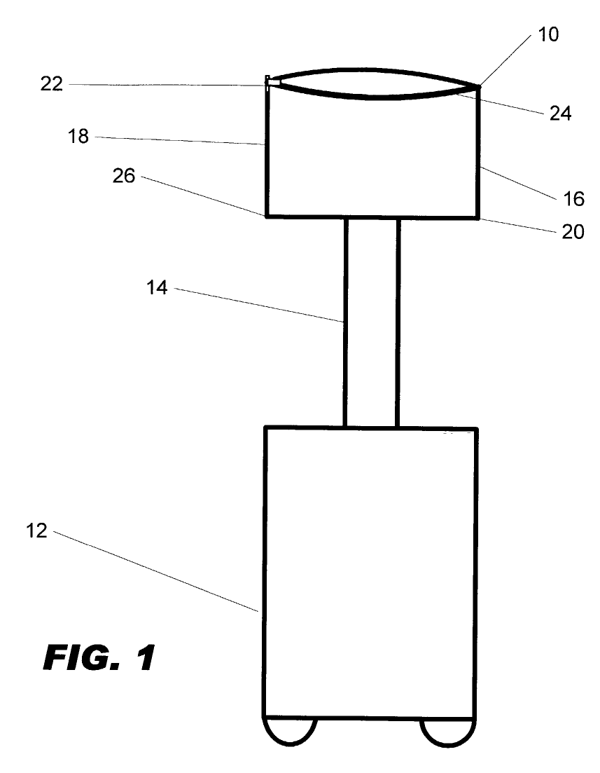

Referring now to the drawings, and particularly to FIGS. 1-3, a preferred embodiment of the attachment for a wheeled container of the present invention is shown and generally designated by the reference numeral 10.

In FIG. 1, a new and improved attachment for a wheeled container 10 of the present invention for pulling luggage, backpacks or baby carriages hands free is illustrated and will be described. More particularly, the attachment for a wheeled container 10 has a wheeled container 12 with a handle 14, a first pole 16 coupled to the wheeled container 12. The pole 16 can be a telescoping pole 18. The pole 16 can also have hinges 20 or can be a U-shaped pole which acts as a hinge. It also comprises a first belt buckle 22 operative to be coupled to the first pole 16, and a belt 24 coupled to the first belt buckle 22. The belt 24 of FIG. 1 is retractable and locks into place once pulled taut. FIG. 1 shows the pole 16 attached to the wheeled container handle which can fold flush into the container handle 14 or into the wheeled container 12 once the handle 14 has been retracted into the wheeled container 12. FIG. 1 also shows a second pole 26 coupled to the wheeled container 12 and a belt buckle 22, coupled to the belt 24, operative to be coupled to the second pole 26. The belt 24 is suitable for connecting to a wheelchair or a baby carriage.

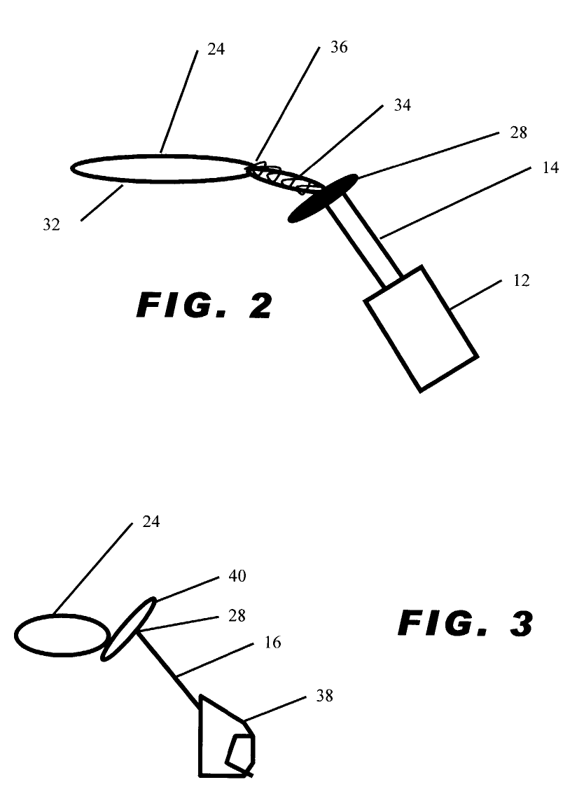

FIG. 2 shows a side view of an attachment for a wheeled container 10 with a handle 14 operative to be coupled to the wheeled container 12, a swivel 28 coupled to the handle 14, a belt 24 coupled to the swivel 28. The belt 24 shown in FIG. 2 is adjustable to fit a user, retractable, and comprises a buckle fastener 32. The belt 24 is made from a material selected from the group consisting of nylon, cotton fabric, plastic, rubber and leather. The swivel 28 shown in FIG. 3 comprises a spring mechanism 34 suitable for absorbing shock and allowing flexibility of the pole 16 so that it can move from an inside position to an outside position easily. The swivel 28 allows lateral movement of the pole 16. The spring mechanism 34 is made from a material selected from the group consisting of metal, plastic, and rubber.

FIG. 2 shows how the swivel 28 is coupled to the handle 14, and the handle 14 is coupled to the spring mechanism 34. The spring mechanism 34 shown in FIG. 2 is coupled to the belt 24. The swivel 28 is made from a material selected from the group consisting of metal, plastic, and wood. The swivel 28 comprises a ball bearing, rolling four-way swivel 36. The swivel 28 can also comprise a simple hinge or a tube for insertion of a U-shaped handle.

FIG. 3 shows the attachment for a wheeled container 10 is suitable for coupling to a suitcase or for coupling to a backpack 38. The swivel 28 and pole 16 are operative to couple between a harness 40 of a backpack 38 and the backpack 38. The harness 40 can also have a belt 24 attached thereto.

While a preferred embodiment of the attachment for a wheeled container has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as metal, plastic, or a variety of wood may be used instead of the metal attachment described. Also, the belt may be made of nylon, cotton fabric, rubber, leather, or similar material. And although pulling luggage with a user's torso has been described, it should be appreciated that the attachment for a wheeled container herein described is also suitable for attaching to a user's wheelchair. Furthermore, a wide variety of containers may be used instead of the luggage and backpacks described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An attachment for a wheeled container comprising:
a wheeled container;
a first pole coupled to the wheeled container;
a first belt buckle operative to be coupled to the first pole; and
a belt coupled to the first belt buckle.

2. The attachment for a wheeled container of claim 1, wherein the pole is a telescoping pole.

3. The attachment for a wheeled container of claim 1, wherein the pole comprise at least one hinge.

4. The attachment for a wheeled container of claim 1, wherein the belt is retractable and locks into place once pulled taut.

5. The attachment for a wheeled container of claim 1, wherein the pole is attached to the wheeled container handle which can fold flush into the container handle.

6. The attachment for a wheeled container of claim 1, further comprising:
a second pole coupled to the wheeled container; and
a second belt buckle, coupled to the belt, operative to be coupled to the second pole.

7. The attachment for a wheeled container of claim 1, wherein the belt is suitable for connecting to a wheelchair.

8. An attachment for a wheeled container, the attachment comprising:
a handle operative to be coupled to the wheeled container;
a swivel coupled to the handle;
a belt coupled to the swivel.

9. The attachment for a wheeled container of claim 8, wherein the belt is adjustable to fit a user.

10. The attachment for a wheeled container of claim 8, wherein the belt is retractable and comprises a buckle fastener.

11. The attachment for a wheeled container of claim 8, wherein the belt is made from a material selected from the group consisting of nylon, cotton fabric, plastic, rubber and leather.

12. The attachment for a wheeled container of claim 8, wherein the swivel comprises a spring mechanism suitable for absorbing shock.

13. The attachment for a wheeled container of claim 12, wherein the spring mechanism is made from a material selected from the group consisting of metal, plastic, and rubber.

14. The attachment for a wheeled container of claim 12, wherein:
the swivel is coupled to the handle;
the handle is coupled to the spring mechanism; and
the spring mechanism is coupled to the belt.

15. The attachment for a wheeled container of claim 8, wherein the swivel is made from a material selected from the group consisting of metal, plastic, and wood.

16. The attachment for a wheeled container of claim 8, wherein the swivel comprises a ball bearing, rolling four-way swivel.

17. The attachment for a wheeled container of claim 8, wherein the attachment is suitable for coupling to a suitcase.

18. The attachment for a wheeled container of claim 8, wherein the attachment is suitable for coupling to a backpack.

19. The attachment for a wheeled container of claim 18, wherein the swivel is operative to couple between a harness of a backpack and the backpack.

20. A method of using an attachment for a wheeled container comprising the steps of:
securing a belt around a user's waist;
locking the belt into place; and
walking while pulling the wheeled container via the belt.
